(19) United States
(12) Patent Application Publication
(10) Pub. No.: US 2017/0200057 A1
(43) Pub. Date: Jul. 13, 2017

(54) IMAGE PROCESSING DEVICE, CHARACTER RECOGNITION DEVICE, IMAGE PROCESSING METHOD, AND PROGRAM

(71) Applicant: OMRON Corporation, KYOTO (JP)

(72) Inventors: Tadashi HYUGA, Hirakata-shi, OSAKA (JP); Tomoyoshi AIZAWA, Kyoto-shi, KYOTO (JP); Hideto HAMABASHIRI, Moriyama-shi, SHIGA (JP)

(73) Assignee: OMRON Corporation, KYOTO (JP)

(21) Appl. No.: 15/327,379

(22) PCT Filed: Oct. 30, 2015
(86) PCT No.: PCT/JP2015/080822

§ 371 Date: Jan. 19, 2017

(30) Foreign Application Priority Data
Oct. 31, 2014 (JP) 2014-223028

(51) Int. Cl. G06K 9/32; G06K 9/46; G06K 9/34

(52) U.S. Cl. CPC G06K 9/325; G06K 9/344; G06K 9/4642; G06K 9/4661

(57) ABSTRACT

An image processing device for performing a preprocessing of an image recognition process to an input image is provided, which includes: a generation element for generating a histogram of luminance values of the input image; a determination element for determining a reference value for the luminance values on the basis of the histogram, and determining a high luminance pixel that is a pixel having a luminance value greater than the reference value; and a conversion element for converting the luminance value of the high luminance pixel into a luminance value that is lower than or equal to the reference value. Thus, even when a high luminance region is present in the input image due to specularly reflected light or the like, high-accuracy character recognition can be performed.

### BACKGROUND OF THE INVENTION

1. Field of the Invention

The present invention generally relates to a type of image processing, in particular, to a type of image processing that is suitable to serve as a preprocessing of a character recognition process.

2. Description of Related Art

Character recognition technologies that involve photographing an object including a character string and recognizing and obtaining the character string from the captured image become popular. Generally, an object has a three-dimensional shape and includes various materials, so that according to a camera disposition position or an illumination condition when an image is captured, sometimes not only diffusely reflected light is photographed, but also specularly reflected light is photographed. A luminance value of the specularly reflected light, as compared with that of the diffusely reflected light, is extremely high, and with the saturation of the luminance value, the specularly reflected light becomes a reason why accuracy of a character cutout process or character recognition process decreases.

For example, binarization of an image is performed as preprocessing prior to a character recognition process. A method, referred to as dynamic binarization, is proposed as a binarization method, that is, in order to eliminate influence of a partial shadow, a threshold is dynamically determined on the basis of a luminance value in a partial region (patent document 1). In this case, if a high luminance region caused by specularly reflected light exists in a captured image, sometimes it is impossible to perform proper binarization, which exerts unfavorable influence on a subsequent character recognition process.

A situation, in which a number plate of a vehicle is used as an object to perform character recognition, is used as an example for further specific description. FIG. 10(a) shows an image obtained by photographing a number plate. The number plate is provided with a character or a number in an embossing manner, and a high luminance region (a saturated region) caused by specularly reflected light is sometimes generated in a stepped difference part that is embossed. FIG. 10(b) shows an example in which a region represented by black is a high luminance region. When a dynamic binarization process is performed on such images, noise may be generated because of influence of a high luminance region. FIG. 10(c) shows a binary image obtained by performing a dynamic binarization process on the image shown in FIG. 10(a). As shown in FIG. 10(c), a region which originally should be considered to have high luminance is determined to have relatively low luminance due to existence of a high luminance region caused by specularly reflected light. If cutout or recognition of a character is performed on the basis of an image with such noise, its accuracy decreases.

The description is merely an example of unfavorable influence exerted by a high luminance region (a saturated region) caused by specularly reflected light. Even in a situation in which a dynamic binarization process is not performed as preprocessing, a situation in which an object is other than a number plate, or the like, accuracy of a character recognition process decreases due to existence of a high luminance region.

### PRIOR ART DOCUMENT

### Patent Document

Patent document 1: JP2003-123023

### SUMMARY OF THE INVENTION

### Problem to be Resolved by the Invention

In view of the facts, the present invention is completed and is directed to providing a technology, which enables high-accuracy character recognition to be implemented even in a situation in which a high luminance region caused by specularly reflected light or the like exists in an input image.

### Technical Means for Resolving the Problem

In order to achieve the objective, in the present invention, as a preprocessing of a character recognition process, a high luminance region of an image is determined, and a pixel value of the high luminance region is converted, so as to suppress unfavorable influence caused by the high luminance region generated because of specularly reflected light or the like.

Specifically, a form of the present invention is an image processing device for performing a preprocessing of an image recognition process to an input image, including: a generation element for generating a histogram of luminance values of the input image; a determination element for determining a reference value for the luminance values on the basis of the histogram and determining a high luminance pixel, that is, a pixel having a luminance value greater than the reference value; and a conversion element for converting the luminance value of the high luminance pixel into a luminance value lower than or equal to the reference value.

In addition, also preferably, in the present invention, the determination element determines one or more peak ranges of luminance values on the basis of the histogram and determines the reference value on the basis of an upper limit value of the peak range having a greatest luminance value.

In addition, also preferably, in the present invention, the determination element determines one or more peak ranges of luminance values on the basis of the histogram and determines the reference value on the basis of an upper limit value of the peak range having a second greatest luminance value.

Moreover, also preferably, in the present invention, the determination element clusters luminance values into multiple ranges on the basis of a difference of a gravity center between a degree corresponding to a luminance value and a degree near the luminance value, and determines a range among the multiple ranges to be the peak range, in which a range width or a sum of degrees in the range is greater than a threshold.

In addition, also preferably, in the present invention, the conversion element converts the luminance value of the high luminance pixel into the reference value.

Moreover, also preferably, in the present invention, the conversion element converts the luminance value of the high luminance pixel into a luminance value calculated on the basis of luminance values of pixels surrounding the pixel.

In addition, another form of the present invention is a character recognition device, including: the foregoing image processing device; and a recognition element for performing a character recognition process on an image processed by the image processing device.

Moreover, also preferably, the input image includes at least one part of a number plate, and the recognition element performs the character recognition process on a character drawn on the number plate.

Furthermore, the present invention can be mastered as an image processing device or a character recognition device including at least one part of the element. In addition, the present invention may also be mastered as an image processing method or a character recognition method. Moreover, the present invention may also be mastered as a computer program used to enable a computer to execute each step of the methods or a computer-readable storage medium that non-temporarily stores the program. The structures and processes can be respectively combined in a scope in which no technical contradiction is generated, so as to constitute the present invention.

### Effect of the Invention

According to the present invention, a high luminance region, caused by specularly reflected light or the like, of an input image can be corrected, so as to suppress unfavorable influence caused by the high luminance region and implement high-accuracy character recognition.

### BRIEF DESCRIPTION OF THE DRAWINGS

FIG. 1 is a brief diagram illustrating a number plate recognition system of a vehicle according to a first implementation manner;

FIG. 2 is a block diagram illustrating a structure of a character recognition device in the first implementation manner;

FIG. 3 is a flowchart illustrating a procedure of a character recognition process in the first implementation manner;

FIG. 4 is a flowchart illustrating a procedure of preprocessing (a correction process on a high luminance pixel) in the first implementation manner;

FIG. 5 is a diagram explaining a histogram of luminance obtained from an input image and a peak range obtained from the histogram;

FIG. 6 is a flowchart illustrating a procedure of clustering for obtaining a peak range in the first implementation manner;

FIG. 7 is a diagram explaining the clustering for obtaining the peak range in the first implementation manner;

FIG. 8 is a diagram illustrating images before and after a correction process on the high luminance pixel of the first implementation manner;

FIG. 9 is a flowchart illustrating a procedure of preprocessing (a correction process on a high luminance pixel) in a second implementation manner; and

FIG. 10 is a diagram explaining unfavorable influence caused by specularly reflected light.

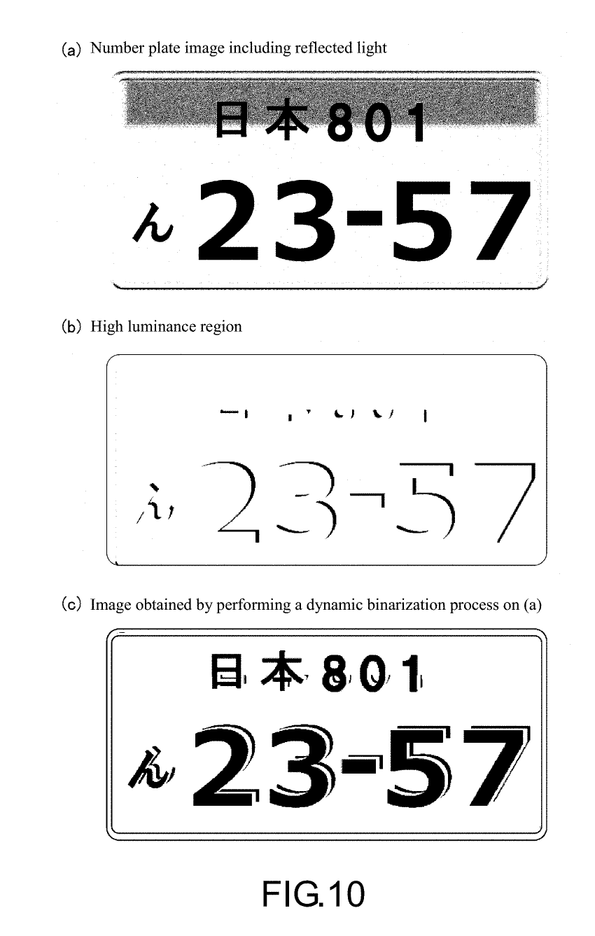

### DESCRIPTION OF THE EMBODIMENTS

Preferable forms for implementing the present invention are illustrated in detail below by referring to the accompanying drawings. However, as long as the size, material, shape, corresponding configuration, or the like of a constituent piece disclosed in the following implementation manners is not specially disclosed, the scope of the present invention is not merely limited to the main idea of the contents.

<First Implementation Manner>

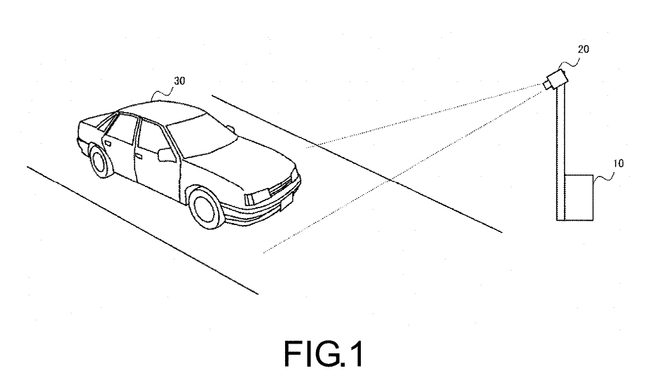

FIG. 1 is a brief diagram illustrating a number plate recognition system of a vehicle according to this implementation manner. The number plate recognition system includes: a camera 20, disposed on a lamp pole erected on a roadside and photographing a vehicle 30 on a road; and a character recognition device (an image processing device) 10, which extracts a number plate from an image captured by the camera 20, so as to determine a character recorded on the number plate.

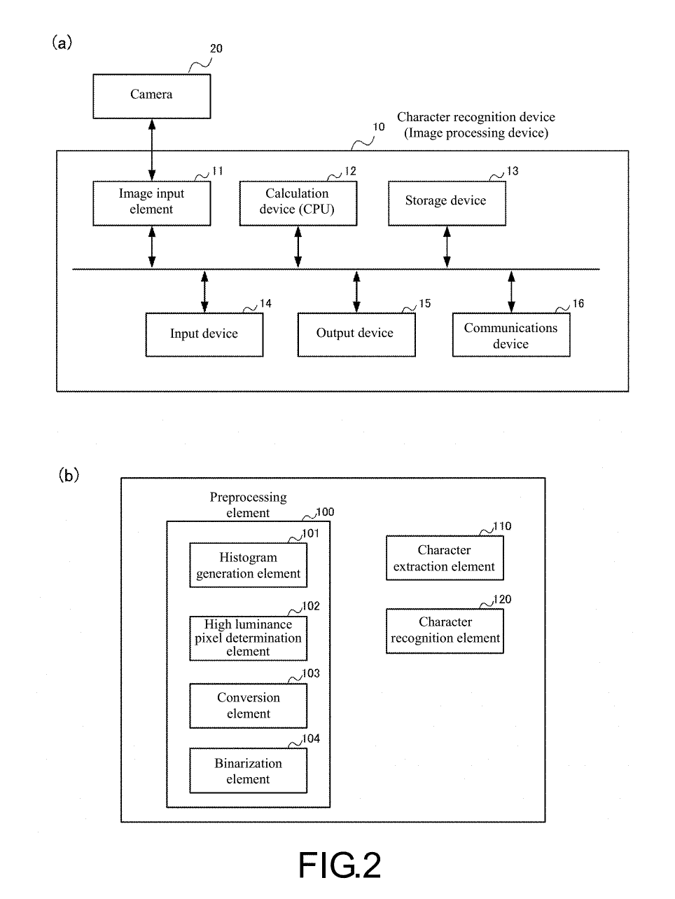

FIG. 2(a) is a diagram illustrating a hardware structure of the character recognition device 10. The character recognition device 10 includes an image input element 11, a calculation device 12, a storage device 13, an input device 14, an output device 15, and a communications device 16. The image input element 11 is an interface for receiving image data from the camera 20. In addition, in this implementation manner, the image data is directly received from the camera 20, but the image data may also be received by using the communications device 16, or the image data may be received by using a recording medium. The calculation device 12 is a general processor and executes a program stored in the storage device 13 to perform subsequent processing. The storage device 13 includes a primary storage device and a secondary storage device, stores the program executed by the calculation device 12, and stores the image data or temporary data in execution of the program. The input device 14 is a device including a keyboard, a mouse, or the like and provided for a user to input an instruction to the character recognition device. The input device 15 is a device including a display device, a speaker, or the like and provided for the character recognition device to perform output to a user. The communications device 16 is a device provided for the character recognition device 10 to perform communication with an external computer. The communications forms may be wired or wireless, and any communications standards may be adopted.

The calculation device 12 executes a program, so as to implement functions shown in FIG. 2(b). That is, the calculation device 12 implements functional element of a preprocessing element 100, a character extraction element 110, and a character recognition element 120. The preprocessing element 100 includes a histogram generation element 101, a high luminance pixel determination element 102, a conversion element 103, and a binarization element 104. Processed contents of the respective element are explained below.

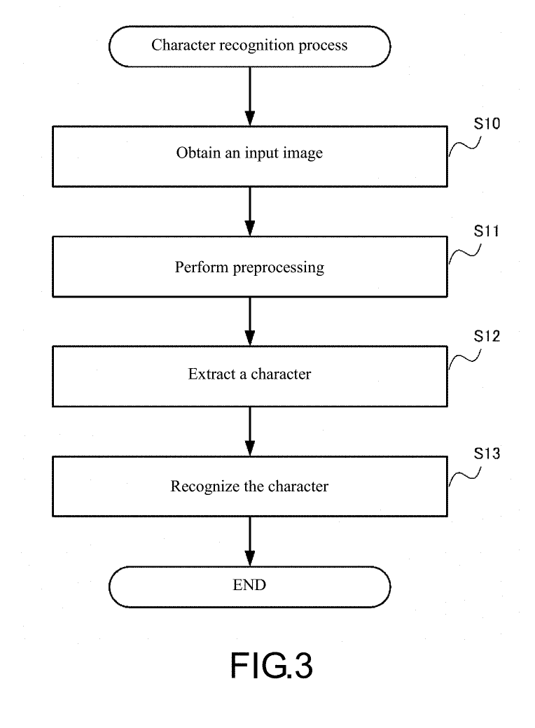

FIG. 3 is a flowchart illustrating an overall procedure of a character recognition process performed by the character recognition device 10. In step S10, the character recognition device 10 obtains image data of a photographed vehicle from the camera 20 by using the image input element 11. The character recognition device 10 extracts a number plate region of the vehicle from the received image to perform subsequent processing on the region. Extraction of the number plate can be performed by merely using an existing method such as template matching, so that descriptions thereof are omitted.

Step S11 is preprocessing performed to adapt the image data to character recognition and is performed by the preprocessing element 100. The preprocessing includes a luminance value correction process on a high luminance pixel of the image, a binarization process, a noise removal process, and the like.

In step S12, the character extraction element 110 extracts a character region from the preprocessed image and further extracts a character region of each character from the character region. In step S13, the character recognition element 120 extracts a feature of a character from each character region and matches the extracted character with each character in dictionary data to perform recognition on the extracted character. Any existing technology is applicable to cutout of a character region and an obtaining or matching process on a character feature amount. For example, a pixel feature extraction method, a contour feature extraction method, a gradient feature extraction method, or the like may be used as a method for obtaining a character feature. In addition, a method, such as a partial space method, a neural network, a Support Vector Machine (SVM), or discriminant analysis, may be used as a character recognition method.

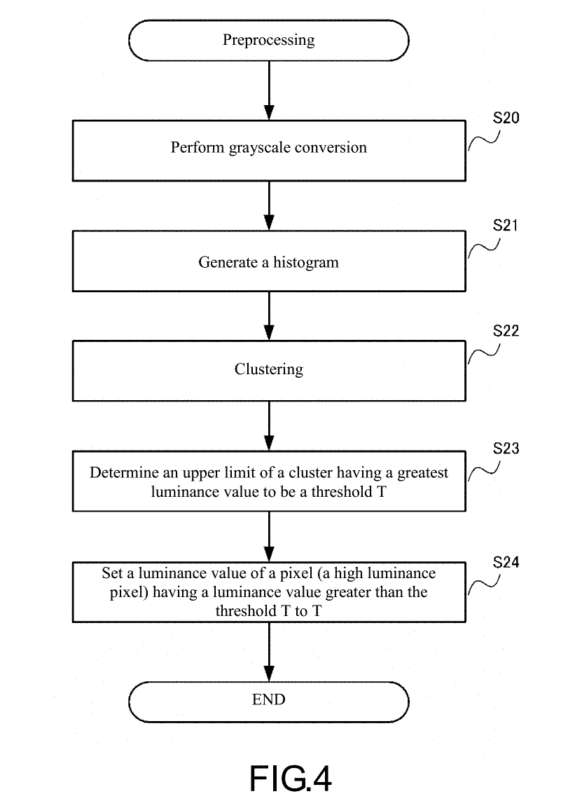

A correction process on a luminance value (a pixel value) of a high luminance pixel in feature processing, that is, preprocessing, in the present invention is described in the following. FIG. 4 is a flowchart illustrating a procedure of preprocessing, in particular, a correction process on a luminance value of a high luminance pixel.

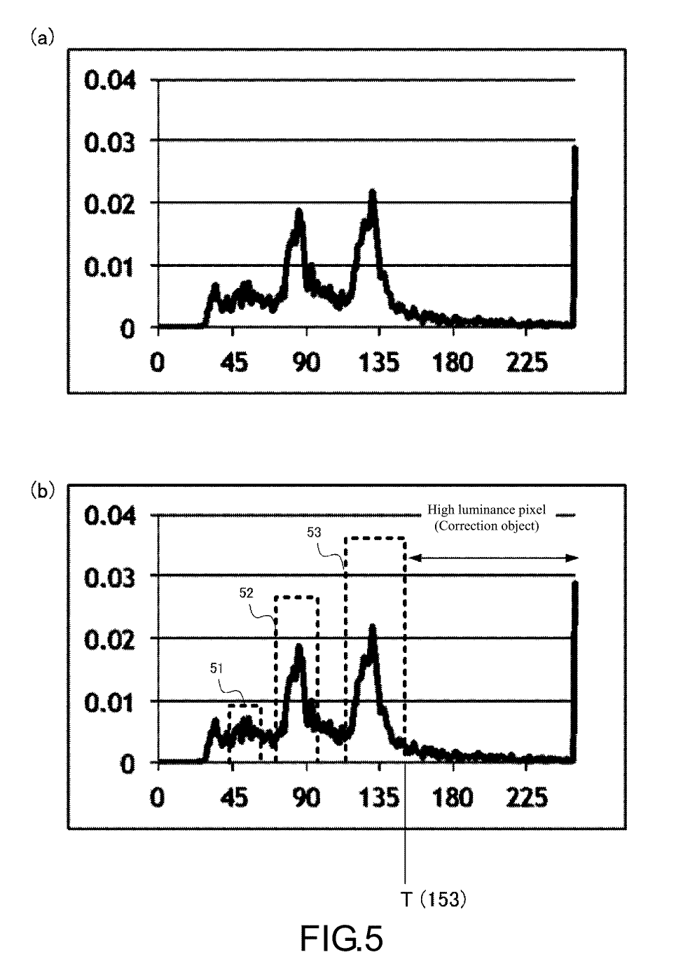

First, in step S20, grayscale conversion is performed on an input image. The number of scales of a grayscale image is not specially defined, and for example, may be set to 256 scales. In step S21, the histogram generation element 101 generates a histogram of luminance values from an image that has been converted into grayscales. In this implementation manner, a bin width of the histogram is set to 1, but the bin with can also be greater than 1. FIG. 5(a) illustrates an example of a generated histogram. In addition, longitudinal axes in FIG. 5(a) (b) represent display scales (density).

In step S22, the high luminance pixel determination element 102 uses the histogram as an object to perform clustering. The clustering is directed to determining a range for obtaining a peak of luminance values and involves determining a peak range to be a cluster. A luminance value outside the peak range is determined to not belong to any cluster. The clustering in step S22 is described in more detail in the following.

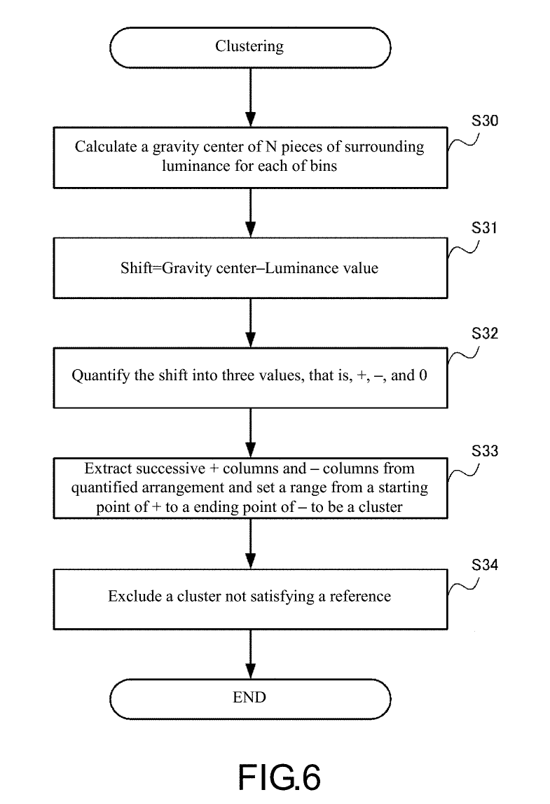

FIG. 6 is a flowchart illustrating a detailed procedure of clustering in step S22. In step S30, with regard to each of the bins (having a meaning the same as that of each of the luminance values in this implementation manner) in the histogram, a gravity center of luminance values in N pieces of surrounding luminance is calculated. For example, N is set to about 10. A gravity center luminance GLi in a luminance value Li may be calculated by using the following equation.

GLi=Σⱼ(Lj×mj)/Σⱼ(mj)

Herein, Σ (sigma) (a sum) is a sum involving j and indicating a range of i−N/2to i+N/2, and mj indicates a degree of a luminance value Lj in the histogram.

In step S31, a difference between the gravity center luminance value GLi and the luminance value Li in each bin (each luminance value) is calculated as a shift Si. That is, an equation is set as:

Si=GLi−Li,

to determine the shift Si.

In step S32, a shift in each bin (each luminance value) is quantified into three values, that is, plus (+), minus (−), and zero (0). In this implementation manner, if the shift Si is 0.5 or above, the shift Si is considered to be plus, if the shift Si is −0.5 or below, the shift Si is considered to be minus, and otherwise, the shift Si is considered to be zero. A value other than 0.5 may be also used as a threshold in the quantification. In addition, the threshold of the quantification may also be changed by using the bin width of the histogram, and for example, may also be a half of the bin width.

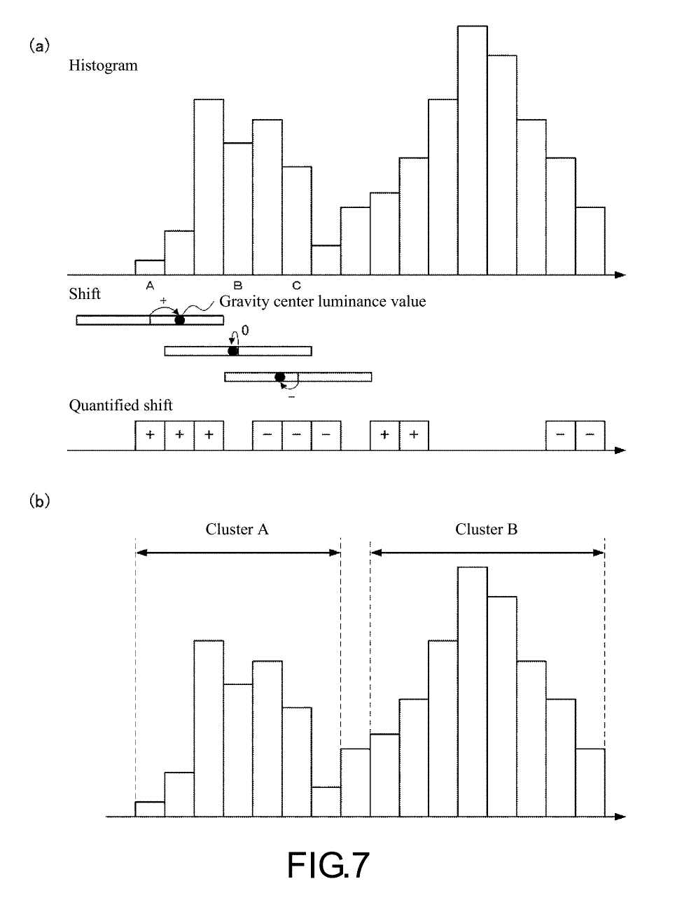

FIG. 7(a) is a diagram schematically illustrating a shift obtained from a histogram of luminance values and an example of the quantified shift. An upper segment of FIG. 7(a) illustrates an example of a histogram that serves as a processing object. A middle segment of FIG. 7(a), with respect to luminance values A, B, and C, illustrates a range (a rectangle) and a gravity center luminance value (a black circle) for obtaining surrounding luminance of the gravity center luminance value. In the drawing, a gravity center luminance value in the luminance value A is greater than the luminance value A by 0.5 or above, indicating that a quantified shift in the luminance value A is plus (+). Similarly, an absolute value of a difference between a gravity center luminance value in the luminance value B and the the luminance value B is less than 0.5, indicating that a quantified shift in the luminance value B is zero (0). Moreover, a gravity center luminance value in the luminance value C is less than the luminance value C by 0.5 or above, indicating that a quantified shift in the luminance value A is minus (−). In the drawing, gravity center luminance values are only illustrated for luminance values A, B, and C, but the same calculation is performed on all luminance values, and quantified shifts are obtained for all the luminance values. A lower segment of FIG. 7(a) illustrates quantified shifts. In addition, the drawing merely clearly shows portions of the quantified shifts that are plus and minus, and for a portion that is neither plus nor minus, the quantified shift is zero.

Return to the descriptions of the flowchart of FIG. 6. In step S33, in arrangement of quantified shifts (also referred to as quantified arrangement), two or more successive plus columns and minus columns are extracted, and a range from a starting point of the plus column to an ending point of the minus column is determined to be a cluster. A clustering result obtained by quantifying shifts shown in FIG. 7(a) is shown in FIG. 7(b). In FIG. 7(a), there are two plus columns and two minus columns respectively, and a pair corresponding to a plus column and a minus column determines two clusters as shown in FIG. 7(b).

In step S34, a cluster that does not satisfy a specified reference is excluded from the clusters obtained in step S33. An example of a reference may be that: a width of a cluster is greater than or equal to a specified threshold; or a sum of degrees (the number of pixels belonging to the cluster) in the cluster is greater than or equal to a specified threshold. A cluster not having a width is removed, and for example, a cluster is effective because it can distinguish a saturated pixel from other peaks. In a case in which an overall image is bright, a peak with a width under a greatest luminance value (which is a luminance value 255 in this implementation manner) is detected, and in a case in which over-exposure is generated because of influence of specularly reflected light and the like, a peak without a width under the greatest luminance value is detected. By regulating conditions concerning the cluster width, a pixel of a correction object can be properly determined in a case in which influence of specularly reflected light exists.

By element of the above, the clustering of step S22 illustrated in the flowchart of FIG. 4 ends. A clustering result of using the histogram shown in FIG. 5(a) as an object is shown in FIG. 5(b). In FIG. 5(b), three clusters 51, 52, and 53 are obtained.

In step S23, the high luminance pixel determination element 102 determines an upper limit value (a greatest value) of luminance values of a cluster having a greatest luminance value in the clusters obtained in step S22 to be a threshold (a reference value) T. The threshold T is used to determine whether a pixel is a high luminance pixel, and more specifically, a pixel having a luminance value greater than the threshold T is determined to be a high luminance pixel. In the example of FIG. 5 (b), the cluster 53 is a cluster having the greatest luminance value, an upper limit value (which is 153 in this example) of luminance of the cluster 53 is determined to be the threshold T, and on the basis of this, a high luminance pixel is determined. In addition, a method of determining a threshold T by adding a specified numeral value to the upper limit value may be used or when a region whose quantified shift is 0 exists in a region having a luminance value greater than the luminance value in the cluster having the greatest luminance value, a method of determining an upper limit value of a luminance value of the region to be the threshold T may be used, so that a processing range can be limited to achieve high speed processing.

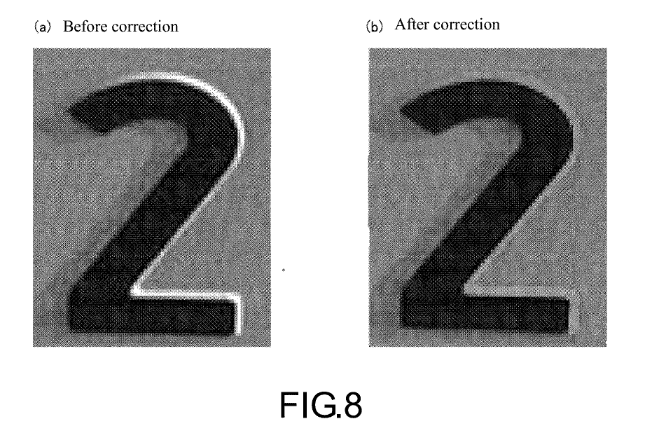

In step S24, the conversion element 103 sets a luminance value of a pixel (a high luminance pixel) having a luminance value greater than the threshold T to T. Hence, all the luminance values of the high luminance pixels in the image are replaced with a value of an upper limit value (T) of the greatest cluster. FIG. 8(a) shows a grayscale image before correction, and FIG. 8(b) shows a grayscale image after correction. As shown in the drawings, performing correction by reducing a luminance value of a high luminance pixel can eliminate influence caused by specularly reflected light.

In addition, the flowchart of FIG. 4 merely shows a correction process on a high luminance pixel, but another process, such as a noise removal process, a binarization process, or a thinning process on a binary image, may also be performed. The processes are well-known processes that are always performed, so that detailed descriptions thereof are omitted, but the binarization process is introduced. Dynamic binarization of dynamically determining a threshold on the basis of luminance values in a partial region may be used as a binarization process. Because correction is performed in a manner of eliminating high luminance pixels, unfavorable influence caused by specularly reflected light can be suppressed by element of a dynamic binarization process, so as to implement proper binarization.

According to this implementation manner, a high luminance pixel of a correction object is determined on the basis of a histogram of luminance values, so that as compared with an approach of performing correction by fixedly determining a luminance value range of a correction object, this implementation manner can suppress influence of specularly reflected light and the like more properly. In addition, influence caused by specularly reflected light can be suppressed, so that accuracy of a character recognition process can be improved.

<Second Implementation Manner>

The second implementation manner differs from the first implementation manner in a determination method of substituting, by the conversion element 103, a luminance value of a high luminance pixel (a correction object pixel) in a correction process. In the first implementation manner, all high luminance pixels are substituted with the threshold T, but in this implementation manner, a luminance value after correction is determined on the basis of luminance values of surrounding pixels of the correction object pixel.

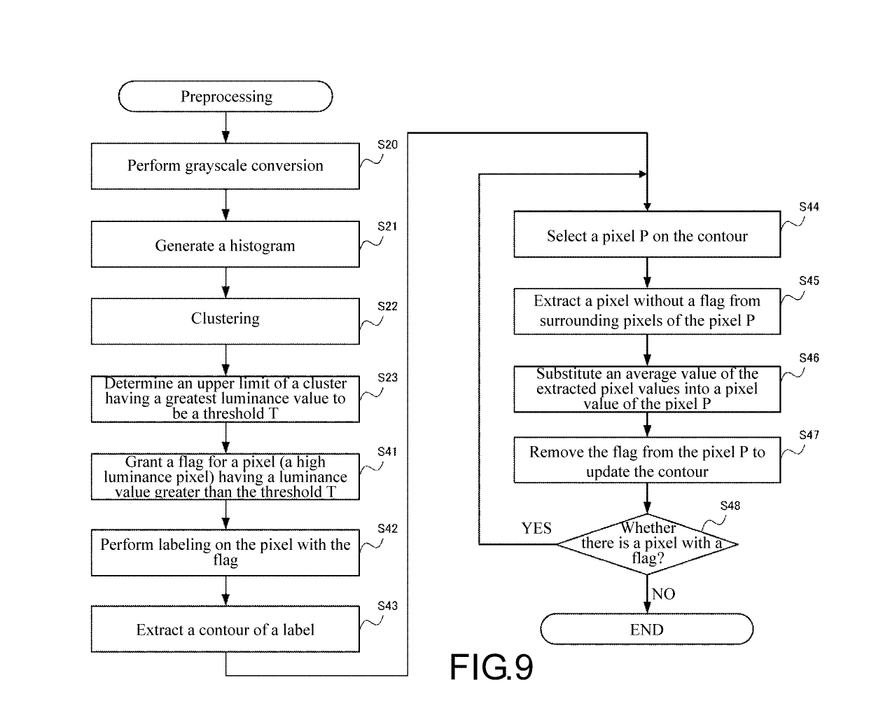

FIG. 9 is a flowchart illustrating a procedure of a luminance value correction process on a high luminance pixel in preprocessing in this implementation manner. Processes in step S20 to step S23 are the same as processes in the first implementation manner, and therefore, descriptions thereof are omitted. In this implementation manner, a process in step S24 performed by the conversion element 103 in the first implementation manner is substituted with processes of step S41 to step S48.

In step S41, a flag is granted for a pixel (a high luminance pixel) having a luminance value greater than a threshold T. In step S42, labeling is performed on the pixel with the flag. In step S43, a contour of a label is extracted.

Processes of step S44 to step S47 are performed on respective pixels on the contour in sequence. In step S44, a pixel on the contour is selected. The selected pixel herein is referred to as a pixel P. In addition, the pixels on the contour extracted in step S43 all have the same priority, and which pixel is first processed does not matter. In step S45, a pixel without a flag is extracted from surrounding pixels of the pixel P. The so-called surrounding pixels, for example, may be pixels (other than the pixel P) in a range of 3×3 to 7×7 with the pixel P as a center or may be four adjacent pixels of the pixel P and the like. In step S46, an average value of luminance values of the pixels extracted in step S47 is calculated, and the average value is substituted as the luminance value of the pixel P. In step S48, the flag is removed from the pixel P, so as to update the contour. In step S48, it is determined whether a pixel with a flag remains, and if so, step S44 is performed again to repeat the process. In addition, in pixel selection in step S44, a pixel whose timing of being extracted as a contour is earlier is more preferentially selected.

According to this implementation manner, interpolation can be smoothly performed on a high luminance pixel region by using luminance values of surrounding pixels. Therefore, it would be difficult for a corrected image to generate a false contour, so that accuracy of a character recognition process can be improved.

<Other Implementation Manners>

Descriptions of the implementation manners are merely used to illustratively explain the present invention, and the present invention is not limited to the specific forms. Various deformations may be performed on the present invention within the scope of the technical idea.

In the descriptions, a system for recognizing a number plate of a vehicle is described, but this system is applicable to any character recognition system. The present invention can be preferably applied to a case in which not only diffusely reflected light but also specularly reflected light of illumination and the like is projected into an image. For example, the present invention can be applied to a character recognition system used in Factory Automation (FA) for recognizing characters recorded on surfaces of aluminum cans or plastics. In addition, the preprocessing in the descriptions is applicable not only as a preprocessing of a character recognition process, but also, preferably, as preprocessing of other image recognition processes.

In addition, in the descriptions, a system that performs image capturing of a camera, a correction process on a high luminance pixel, and a character recognition process is described, but the image may also be obtained by element of a method other than photographing of a camera. For example, the present invention can be constituted as a character recognition device described below, where the character recognition device obtains an image by element of data communication or a recording medium and performs a correction process and a character recognition process on the obtained image. Moreover, the present invention can also be constituted as an image processing device that merely performs a correction process on an image.

In the descriptions, in order to determine a peak range from a histogram, clustering is used, but a peak range can also be determined by using a method other than clustering. For example, determining a degree threshold according to an overall luminance value of an image and determining a range having a degree greater than the threshold to be a peak range may be taken into consideration. At this time, also preferably, when a width of the peak range determined in this way is less than a specified value or the number of pixels in the peak range is less than a specified value, the peak range is not processed as a peak range. In addition, in this method, a saturated region may become a peak range, and in this case, a reference value may also be determined on the basis of a peak range having a second greatest luminance value rather than a peak range having a greatest luminance value.

In the descriptions, an example of providing a function by executing, by a general processor, a software program is described, but a dedicated hardware circuit may also be used to provide the function.

The character recognition device of this implementation manner may be mounted in any device such as a desktop computer, a notebook computer, a slate computer, or a smart phone. In addition, respective functions of the character recognition device in the descriptions do not need to be implemented by one device and may also be implemented by multiple devices by sharing their respective functions.

### REFERENCE SIGNS LIST

10: Character recognition device (Image processing device)

100: Preprocessing element

101: Histogram generation element

102: High luminance determination element

103: Conversion element

104: Binarization element

110: Character extraction element

120: Character recognition element

20: Camera

1. An image processing device for performing a preprocessing of an image recognition process to an input image, comprising:
a generation element for generating a histogram of luminance values of the input image;
a determination element for determining a reference value for the luminance values on the basis of the histogram and determining a high luminance pixel, that is, a pixel having a luminance value greater than the reference value; and
a conversion element for converting the luminance value of the high luminance pixel into a luminance value lower than or equal to the reference value.

2. The image processing device as claimed in claim 1, wherein:
the determination element determines one or more peak ranges of luminance values on the basis of the histogram and determines the reference value on the basis of an upper limit value of the peak range having a greatest luminance value.

3. The image processing device as claimed in claim 1, wherein:
the determination element determines one or more peak ranges of luminance values on the basis of the histogram and determines the reference value on the basis of an upper limit value of the peak range having a second greatest luminance value.

4. The image processing device as claimed in claim 2, wherein:
the determination element clusters luminance values into multiple ranges on the basis of a difference of a gravity center between a degree corresponding to a luminance value and a degree near the luminance value, and determines a range among the multiple ranges to be the peak range, in which a range width or a sum of degrees in the range is greater than or equal to a threshold.

5. The image processing device as claimed in claim 1, wherein:
the conversion element converts the luminance value of the high luminance pixel into the reference value.

6. The image processing device as claimed in claim 1, wherein:
the conversion element converts the luminance value of the high luminance pixel into a luminance value calculated on the basis of luminance values of pixels surrounding the pixel.

7. A character recognition device, comprising:
the image processing device as claimed in claim 1; and
a recognition element for performing a character recognition process on an image processed by the image processing device.

8. The character recognition device as claimed in claim 7, wherein:
the input image comprises at least one part of a number plate, and the recognition element performs the character recognition process on a character drawn on the number plate.

9. An image processing method, executed by an image processing device and comprising:
a generation step of generating a histogram of luminance values of an input image;
a determination step of determining a reference value for the luminance values on the basis of the histogram and determining a high luminance pixel, that is, a pixel having a luminance value greater than the reference value; and
a conversion step of converting the luminance value of the high luminance pixel into a luminance value lower than or equal to the reference value.

10. A program, used for enabling a computer to execute each step of the method as claimed in claim 9.
